(19) United States
(12) Patent Application Publication
(10) Pub. No.: US 2009/0024557 A1
(43) Pub. Date: Jan. 22, 2009

(54) Clause and Proof Tightening

(76) Inventors: Oded Fuhrmann, Zichron Yackov (IL); Ohad Shacham, Kfar Monash (IL); Ofer Strichman, Tivon (IL); Tatyana Veksler, Zichron Yaakov (IL)

Correspondence Address: IBM CORPORATION, T.J. WATSON RESEARCH CENTER, P.O. BOX 218, YORKTOWN HEIGHTS, NY, 10598, US

(21) Appl. No.: 11/779,304

(22) Filed: Jul. 18, 2007

(51) Int. Cl. G06N 7/08; G06F 17/10

(52) U.S. Cl. 706/58; 703/2

(57) ABSTRACT

A computer-implemented method for verification of a target system includes defining a formula describing the target system, the formula including clauses, which include variables and which express constraints on states of the target system. The formula is processed so as to derive, using the clauses, a proof relating to a property of the target system. After deriving the proof, a variable that has a constant value is identified in the proof. The number of the variables in the proof is reduced using the identified variable, thereby producing a tightened expression, which is applied in making a determination of whether the target system satisfies the formula.

### FIELD OF THE INVENTION

The present invention relates generally to methods for solving propositional satisfiability problems, with specific applicability, inter alia, to formal verification.

### BACKGROUND OF THE INVENTION

Various methods are known in the art for automatically solving propositional satisfiability (SAT) problems. A software engine for solving SAT problems is commonly referred to as a “SAT solver.” Most modern SAT solvers are variations on the well-known DPLL framework, which is described, for example, by Davis et al., in “A Machine Program for Theorem-Proving,” Communications of the ACM 5:7 (1962), pages 394-397. In this procedure, the SAT solver performs a backtracking search through a decision tree. At each node in the tree, the procedure chooses and tests an assignment, i.e., it selects a variable and assigns a Boolean value to the variable. The well-known unit clause rule is then used iteratively to deduce the assignments of additional variables, based on the assignment under test, in a procedure known as Boolean Constraint Propagation (BCP). If a given assignment is tested and is found to lead to a contradiction, the tree is pruned, using logical rules to remove paths that will not yield fruitful results.

For efficient BCP processing, it is useful to frame the SAT problem in conjunctive normal form (CNF). A CNF formula φ on n binary variables x₁, . . . , xₙ is a conjunction (AND) of m “clauses” ω₁, . . . , ωₘ each of which is a disjunction (OR) of one or more “literals.” A literal is an occurrence of one of the variables or its complement (NOT). It is known in the art that any Boolean expression can be cast in CNF, and there are automatic tools available for transforming arbitrary Boolean expressions to CNF. The SAT problem is solved when an assignment to the variables x₁, . . . , xₙ is found that makes all the clauses true, or when it is proved that there is no such assignment.

In the course of the SAT-solving procedure, conflicts typically arise when a given unassigned variable must be simultaneously TRUE to satisfy one of the clauses and FALSE to satisfy another. When such a conflict occurs, the procedure must backtrack to try a different assignment. The analysis of such conflicts allows “conflict clauses” to be computed and added to the CNF formula (also referred to as the “clause database”) as constraints on the search. A conflict clause represents an auxiliary sub-formula, such that any assignment that fails to satisfy the sub-formula will invariably lead to a conflict in the original formula.

In many types of SAT problems, multiple, related SAT instances must be solved. In such cases, it is useful to reuse information (the conflict clauses) found in one instance in order to solve the next instance more efficiently. Techniques for sharing conflict clauses among SAT instances are described, for example, in U.S. Pat. No. 7,047,139, whose disclosure is incorporated herein by reference. This patent also explains the usefulness of these techniques in formal verification, and particularly in the method of formal verification known as “bounded model checking” (BMC). This latter method is described, for example, by Biere et al., in “Symbolic Model Checking without BDDS,” Proceedings of the Conference on Tools and Algorithms for the Construction and Analysis of Systems—TACAS99 (Springer-Verlag Lecture Notes in Computer Science, 1999). BMC considers only counterexamples up to a particular length k and generates a propositional formula that is satisfiable iff (if and only if) such a counterexample exists.

### SUMMARY OF THE INVENTION

Embodiments of the present invention provide methods, apparatus and software that may be used for verification of a target system. A formula is defined describing the target system. The formula includes clauses, which include variables and which express constraints on states of the target system. The formula is processed so as to derive, using the clauses, a proof relating to a property of the target system.

After deriving the proof, a variable that has a constant value is identified in the proof. The number of the variables in the proof is reduced using the identified variable, thereby producing a tightened expression, which may be a tightened proof or a tightened clause. This tightened expression is applied in making a determination of whether the target system satisfies the formula. An output may be generated to indicate a verification status of the target system responsively to the determination.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a SAT-checking system, in accordance with a preferred embodiment of the present invention;

FIGS. 2 and 3 are resolution graphs, which schematically show a resolution proof of a conflict clause before and after clause tightening, respectively, in accordance with an embodiment of the present invention; and

FIG. 4 is a flow chart that schematically illustrates a method for incremental SAT solving, in accordance with an embodiment of the present invention.

### DETAILED DESCRIPTION OF EMBODIMENTS

Embodiments of the present invention that are described hereinbelow provide methods, systems and software for tightening of conflict clauses and proofs that are generated by SAT solvers, and particularly by SAT solvers that follow the DPLL framework described above. In the context of the present patent application, “tightening” means either reducing the number of variables that are included in a clause or reducing the number of clauses used in a proof. For convenience in the description that follows and in the claims, the term “expression” is used to refer collectively to both clauses and proofs containing such clauses. When an expression of this sort is tightened, the number of variables that are contained in the expression is reduced.

Tighter clauses and proofs enhance the efficiency of subsequent operations of the SAT solver in which the clauses or proofs are used. For example, when the conflict clauses are reused in successive instances in a bounded model checking approach to formal verification of a hardware or software design, tighter clauses prune larger portions of the search space and thus enable the SAT solver to reach a solution in fewer steps.

In embodiments of the present invention, clauses and proofs are tightened by using knowledge derived by the SAT solver after having inferred the clause or proof in question. The tightening procedure uses the knowledge that a given variable must have a constant value (either true or false) in order to simplify proofs that contain the given variable, and thus to simplify clauses that are derived through such proofs. Specifically, the disclosed embodiments simplify resolution proofs in which a constant-valued variable serves as a pivot, as defined hereinbelow. The principles of the present invention may be extended, however, to tightening of resolution proofs in which a proof is known for a clause that is subsumed by one of the clauses of the original resolution proof.

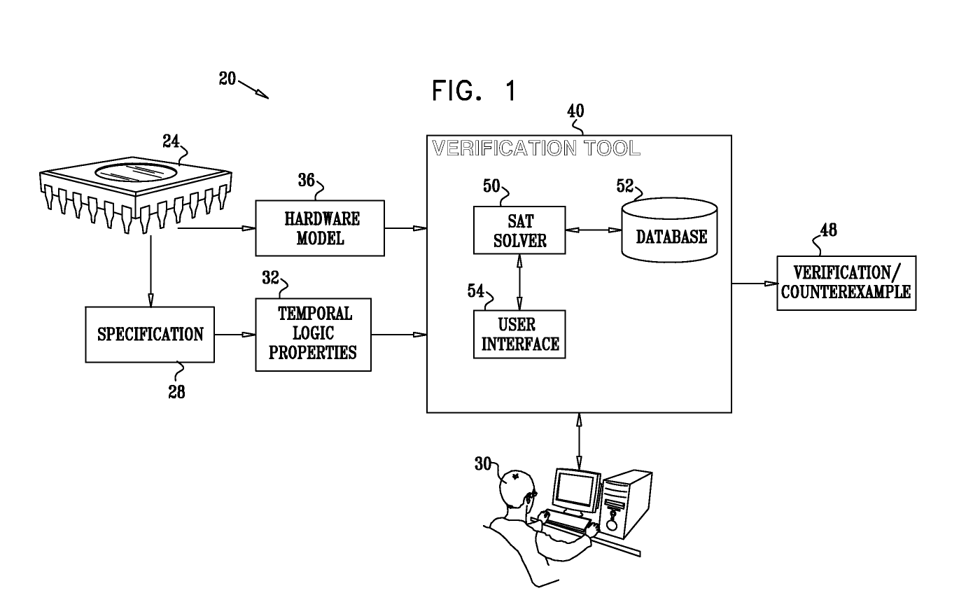

FIG. 1 is a block diagram that schematically illustrates a system 20 for formal verification of a target system, such as a hardware device 24, in accordance with an embodiment of the present invention. Device 24 may comprise an integrated circuit (IC), an application-specific IC (ASIC), a field-programmable gate array (FPGA), a microprocessor, or any other suitable digital hardware device or target system. Alternatively, the principles of the present invention may be applied, mutatis mutandis, in formal verification of software programs, as well as in other sorts of decision procedures in fields such as automated reasoning, artificial intelligence, and circuit layout. Details of system 20 and device 24 are presented below by way of example, and not limitation.

A specification 28 defines the functional behavior and/or the performance that the design of device 24 is expected to fulfill. In order to verify the design, a user 30, typically a verification engineer, converts the specification into properties 32, typically written in temporal logic. Temporal logic, as is known in the art, is a specification language suitable for expressing relationships between the variables of the design over time. The specification is used in verifying a hardware model 36 of device 24, which typically represents the device as a finite state machine. Model 36 may be written in a suitable hardware description language (HDL), such as VHDL or Verilog.

Model 36 is then tested by a verification tool 40 to ascertain that the model satisfies all of properties 32 under all possible input sequences. For this purpose, tool 40 attempts to find a counterexample that violates a particular property p among properties 32. The tool generates a Boolean formula (referred to as a SAT instance) that is satisfiable if and only if such a counterexample exists. Satisfying the Boolean formula is equivalent to finding a counterexample to p. To test the formula, tool 40 uses a SAT solver 50, such as the SAT solver described in the above-mentioned U.S. Pat. No. 7,047,139 or any other suitable type of SAT solver that is known in the art. The SAT solver stores the clauses of the Boolean formula in a clause database 52, along with conflict clauses and other search-related information. User 30 interacts with tool 40 via a suitable user interface 54.

After checking a given instance or set of instances, tool 40 produces an output 48 indicative of the verification status of the model. The output may comprise a counterexample, if one is found, or an indication that no counterexample could be found, in which case the property in question is considered to have been verified.

Typically, SAT solver 50 comprises a general-purpose computer, which is programmed in software to carry out the functions described herein. The software may be downloaded to the computer in electronic form, over a network, for example, or it may alternatively be supplied to the computer on tangible media, such as CD-ROM. The computer comprises a memory for holding clause database 52, as well as other search-related data. Alternatively, solver 50 may be implemented using a combination of dedicated hardware and software elements. The solver may be a standalone unit, or it may alternatively be integrated with other components of tool 40.

SAT solver 50 is assumed to follow the DPLL framework. DPLL SAT solvers construct proofs based on inference rules using binary resolution. An inference rule is a relation between propositions called “antecedents” and a resulting proposition, called a “consequence.” A proof P is a finite set of inferences with an acyclic antecedence relation. The set of consequences of P are the propositions that P proves, assuming the root antecedents (also called “premises”) of P to be true.

A binary resolution inference rule is defined over a set of variables {1, 1₁, 1₂, . . . , 1ₙ, 1₁′, 1₂′, . . . , 1ₘ′} as follows:

$$\frac{( l ⋁ {l}_{1} ⋁ {l}_{2} ⋁ … ⋁ {l}_{n} ) ( l ⋁ {l}_{1}^{′} ⋁ {l}_{2}^{′} ⋁ … ⋁ {l}_{m}^{′} )}{( {l}_{1} ⋁ {l}_{2} ⋁ … ⋁ {l}_{n} ⋁ {l}_{1}^{′} ⋁ {l}_{2}^{′} ⋁ … ⋁ {l}_{m}^{′} )} \qquad ( 1 )$$

The two premises of the rule are listed above the line, and the consequence below. The resolution function receives two clauses with complementary literals, l and [symbol] l as input and returns the consequence of the resolution rule as output. The variable l is referred to as the “pivot” or “resolution variable.” As a formal expression of equation (1), the rule states that given antecedent clauses C₁=l [symbol] l ₁ [symbol] l₂ [symbol] . . . [symbol] lₙand C₂=( [symbol] l [symbol] l₁′ [symbol] l_{z}′ [symbol] . . . [symbol] lₘ6′)

Resolution (C₁, C₂)=(l₁ [symbol] l ₂ [symbol] . . . [symbol] lₘ6′) (2)

### and Pivot (C₁, C₂)=l.

Resolution is known to be a sound and complete proof system for CNF formulas. Specifically, a CNF formula φ is unsatisfiable if and only if there exists a resolution proof of the empty clause using the clauses of φ as a premise.

A resolution proof is a composite of resolutions of the type described above in expressions (1) and (2). The resolution proof can be represented by a corresponding resolution graph, which is a directed acyclic graph (DAG) in which the nodes represent clauses of the proof. For every pair of nodes in the graph, Cᵢ and Cⱼ, there is an edge (Cᵢ, Cⱼ) if and only if Cⱼ is an antecedent of Cᵢ in the resolution proof. The leaf nodes of the resolution graph are the assumptions of the proof. If the resolution graph has a root, the clause at the root is the consequence of the proof. For any given node in the resolution graph, the leaf nodes that can be reached by tracing the edges back from the given node are the support of the given node. If the consequence of a resolution graph is an empty clause, then the set of leaf clauses of the graph are referred to as an unsatisfiable core of the original set of clauses.

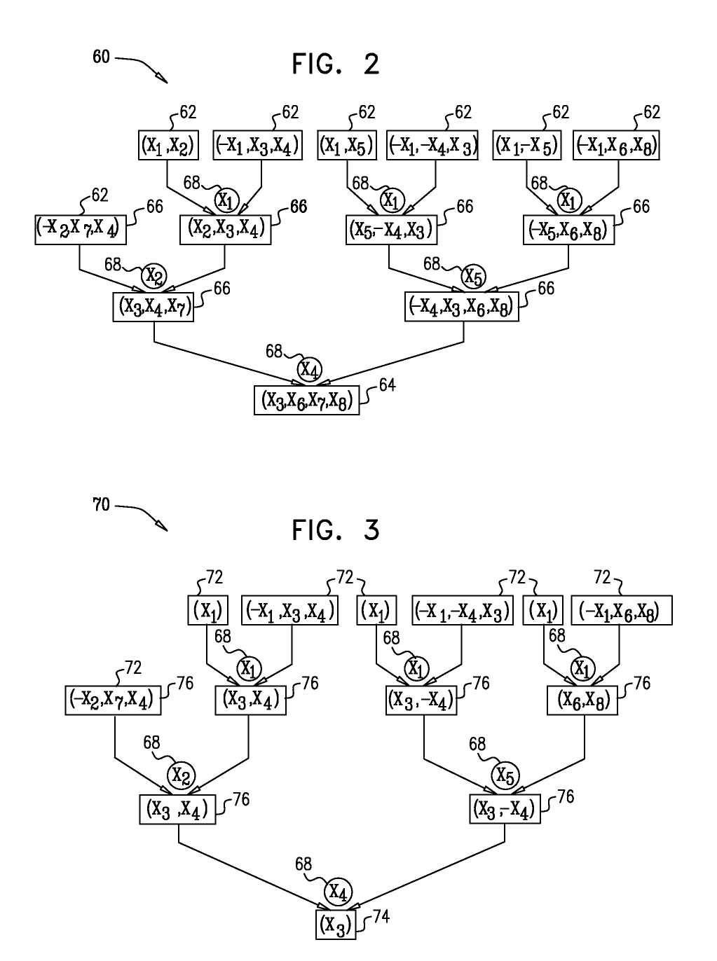

FIG. 2 is a resolution graph 60 according to the above definition, in accordance with an embodiment of the present invention. The graph represents a resolution proof in CNF. For compactness and simplicity, the notation (xᵢ, xⱼ) is used in the graph to mean (xᵢ [symbol] xⱼ), while −xᵢ refers to the complement [symbol] xᵢ.

Graph 60 begins with a set of premises (assumptions) at leaves 62 and concludes with a consequence at a root 64. This graphical representation may be applied to any resolution proof, but it is assumed for the purposes of the present patent application that the consequential clause (x₃, x₆, x₇, x₈) that is shown at root 64 is a conflict clause, which is derived by SAT solver 50 in the manner described above. The clause at each intermediate node 66 (and ultimately at root 64) is determined by resolution of the clauses at a pair of nodes in the preceding level, which are connected by edges directed to the intermediate node. For each such resolution, a corresponding pivot 68 is shown in graph 60.

FIG. 3 is a resolution graph 70, exemplifying a process of proof and clause tightening as applied to graph 60, in accordance with an embodiment of the present invention. For the purposes of this graph, it is assumed that after deriving graph 60, SAT solver 50 determines that the value of variable x₁ must be TRUE, i.e., x₁ has a constant Boolean value. (This determination may be based, for example, on derivation of a new conflict clause (x₁) by the SAT solver.) As a result of determining that x₁ must be TRUE, leaves 62 in graph 60 that contain x₁ will have this same constant value. The corresponding leaves 72 in graph 70 are therefore simplified, as shown in FIG. 3. In the resolutions in graph 70 in which x₁ is the pivot, the consequences in intermediate nodes 76 are tightened accordingly.

For example, the two leftmost leaves 62 in the upper row of graph 60 represent the clauses C₁=(x₁ [symbol] x₂) and C₂=( [symbol] x₁ [symbol] x₃ [symbol] x₄). Based on these clauses, SAT solver 50 infers the new clause C₃=(x₂ [symbol] X₃ [symbol] x₄), as shown in FIG. 2. Upon adding the new conflict clause C₄=(x₁) in FIG. 3, resolution of C₂ and C₄ gives the new, tighter clause C₅=(x₃ [symbol] x₄) at node 76 as the consequence of these leaves 72 in place of C₃ at the corresponding node 66 in graph 60. In this case, C₅ is said to subsume C₃, since if C₅ is TRUE, then C₃ is necessarily also TRUE. A similar process is applied to the other leaves that contain x₁. The consequences of intermediate nodes 76 are also affected by the tightening of the corresponding clauses, leading to the consequence that root 74 of graph 70 now contains the unit conflict clause (x₃). The SAT solver may then use this new clause in tightening other proofs and clauses in database 52.

The tightening procedure that was applied to graph 60 in order to arrive at graph 70 may be represented in terms of an abstract recursive procedure T, which is defined formally in Table I below. In this definition, S is the set of unit conflict clauses that the SAT solver has learned. The procedure is triggered for each variable in S that appears as a pivot in graph 60. It begins with the leaf nodes above the pivot and then operates recursively on each of the consequent nodes in the original graph in order to arrive at the tightened graph.

In the formal definition of Table I, C is the clause considered at the current stage in the recursion. For leaves in the graph, T(C)=C. For other nodes, C=Resolution (C.L, C.R), i.e., C.L and C.R are the clauses that are resolved to give C, wherein piv=Pivot (C.L, C.R). Comments explaining the rationale behind the table, keyed to the numbers in the last column of the table, are presented below.

TABLE I
RECURSIVE TIGHTENING PROCEDURE

| piv ∈ T(C.L) | [symbol] piv ∈ T(C.R) | T(C) = | | | Comment |
|---|---|---|---|---|---|
| | | | ( ) | (piv ∈ S) [symbol] ( [symbol] piv ∈ S) | 1 |
| | | | Resolution((piv), T(C.R)) | (piv ∈ S) [symbol] ( [symbol] piv ∉ S) | |
| yes | yes | {open oversize brace} | Resolution(T(C.L), ( [symbol] piv)) | (piv ∉ S) [symbol] ( [symbol] piv ∈ S) | |
| | | | Resolution(T(C.L), T(C.R)) | (piv ∉ S) [symbol] ( [symbol] piv ∉ S) | |

| | | | |
|---|---|---|---|
| no | no | Either T(C.L) or T(C.R) | 2 |
| no | yes | T(C.L) | 3 |
| yes | no | T(C.R) | 4 |

Comments:
1) The first, contradictory case in the first row of the table is not possible in known SAT solvers, and therefore T(C)=0. In the second case, C.L can be replaced by (piv), as illustrated in the example presented above. Resolution of piv with C.R results in a clause that subsumes C or is equal to C. The third case is the dual of the second case, while in the last case no tightening is possible.
2) Both T(C.L) and T(C.R) are implied by the assumptions, and thus both subsume or are equal to C. The choice of T(C.L) or T(C.R) to replace C can be made heuristically. Typically, it is advantageous to choose whichever of T(C.L) and T(C.R) is shorter, i.e., contains fewer literals.
3) T(C.L) is implied by the assumptions, and thus subsumes C.
4) T(C.R) is implied by the assumptions, and thus subsumes C.

Table II below is a pseudocode representation of a recursive method for clause tightening, in accordance with an embodiment of the present invention. This method implements the principles of the abstract procedure T that is shown in Table I.

TABLE II
CLAUSE TIGHTENING METHOD
clause TighteningClause (P,S)

| | |
|---|---|
| 1. | C = P.root |
| 2. | if (isLeaf (C)) |
| 3. | return C |
| 4. | piv = Pivot (C.L, C.R) |
| 5. | if (piv ∈ S) |
| 6. | C.L = (piv) |
| 7. | else |
| 8. | C.L = TightenClause (Proof (C.L, S) |
| 9. | if ( [symbol] piv ∈ S) |
| 10. | C.R = ( [symbol] piv) |
| 11. | else |
| 12. | C.R = TightenClause (Proof (C.R), S) |
| 13. | if (piv ∉ C.L \hat{ } [symbol] piv ∉ C.R) |
| 14. | choose side ∈ {R,L} |
| 15. | return C.side |
| 16. | else if (piv ∉ C.L \hat{ } [symbol] piv ∈ C.R) |
| 17. | return C.L |
| 18. | else if (piv ∈ C.L \hat{ } [symbol] piv ∉ C.R) |
| 19. | return C.R |
| 20. | else |
| 21. | return (Resolution(C.L, C.R)) |

The method of Table II accepts a proof P of a clause C and a set S of all the literals (i.e., unit conflict clauses) that have already been proved. It returns a clause C′, which either subsumes or is equal to C. It is assumed, without loss of generality, that Pivot (C.L, C.R) ε C.L and [symbol] Pivot (C.L, C.R) ε C.R. The function Proof, which is used in the method, receives a clause C as input and returns the sub-DAG of the resolution graph G of P that is rooted at C. Application of the method of Table III to graph 60 (FIG. 2) results in the tightened clause (x₃) at root 74 in graph 70 (FIG. 3).

Table III below is a pseudocode representation of a recursive method for proof tightening, in accordance with another embodiment of the present invention.

TABLE III
PROOF TIGHTENING METHOD
<core, clause> TightenProof_main (proof P)

| | |
|---|---|
| 1. | Let G be the proof graph corresponding to P. |
| 2. | Let S be the set of literals that appear in unit |
| | clauses in G's non-leaf nodes. |
| 3. | Let OS be an ordered set made of S's elements, such |
| | that lᵢ is before lⱼ if lᵢ can reach lⱼ in G. |
| 4. | return TightenProof (P, OS) |

<core, clause> TightenProof (P, OS)

| | |
|---|---|
| 1. | C = P.root |
| 2. | if (isLeaf (C)) |
| 3. | return <C, C> |
| 4. | piv = Pivot (C.L, C.R) |
| 5. | if (piv ∈ OS) |
| 6. | <Core_{L}, C.L> = TightenProof (Proof (piv), OSₚᵢᵥ) |
| 7. | else |
| 8. | <Core_{L}, C.L> = TightenProof (Proof (C.L), OS) |
| 9. | if ( [symbol] piv ∈ OS) |
| 10. | <Core_{R}, C.R> =TightenProof (Proof ( [symbol] piv), OS [symbol] piv) |
| 11. | else |
| 12. | <Core_{R}, C.R> = TightenProof (Proof (C.R), OS) |
| 13. | if (piv ∉ C.L \hat{ } [symbol] piv ∉ C.R) |
| 14. | choose side ∈ {R, L} |
| 15. | return <Core_{side}, C.side> |
| 16. | else if (piv ∉ C.L \hat{ } [symbol] piv ∈ C.R) |
| 17. | return <Core_{L}, C.L> |
| 18. | else if ( piv ∈ C.L \hat{ } [symbol] piv ∉ C.R) |
| 19. | return <Core_{R}, C.R> |
| 20. | else |
| 21. | return <Core_{L} U Core_{R}, Resolution (C.L, C.R) ) |

The method shown in the table above accepts a proof P of a clause C and returns a tuple (core, clause), wherein

the clause subsumes or is equal to C, and “core” is the subset of the premises S of P that imply the clause. (This method returns only the core of the tightened proof, but it may be modified in a straightforward manner to return the tightened proof itself.) The function Proof (C) that is used in Table III accepts a clause C and returns its proof, as in Table II. The function TightenProof assumes, as in Table II, that Pivot (C.L, C.R) ε C.L and [symbol] Pivot (C.L, C.R) ε C.R.

In contrast to the method of clause tightening shown in Table II, the method of Table III operates on an ordered set of constraints, OS, in order to prevent circular reasoning. The ordered set is extracted from P and contains all the literals that were proved by P, ordered according to the time at which each clause was created. This temporal total ordering guarantees that the order of the literals in OS is consistent with provability relations among the literals. Alternatively, a logical partial ordering may be derived and used for the same purpose. For an ordered set OS=(l₁, . . . , 1ₙ), the prefix of OS up to (but not including) the literal lₖ is represented as OSₗ_{ₖ}=(l₁, . . . , lₖ₋₁)

Application of the proof-tightening method of Table III to graph 60 will result both in simplification of the clauses appearing in the graph (as in graph 70) and elimination of nodes and corresponding literals that are no longer needed for the proof. For example, applying the method of Table III using the conflict clause (x₁) will result in elimination of the two leftmost leaves 62 in the upper row of graph 60, which represent the clauses C₁=(x₁ [symbol] x₂) and C₂=( [symbol] x₁ [symbol] x₃ v x₄). In the resulting, tightened proof graph, the tightened clause C₅=(x₃ [symbol] x₄) (shown at the corresponding node 76 in graph 70) will now appear as a leaf.

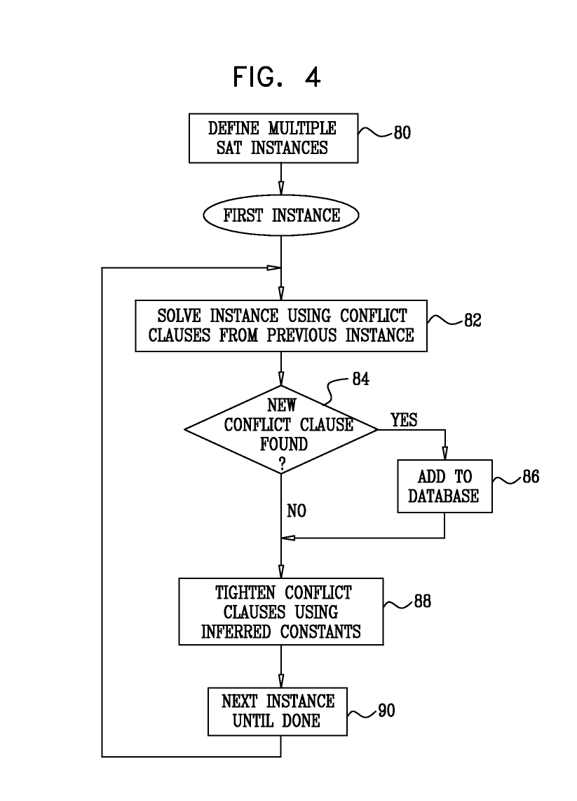

FIG. 4 is a flow chart that schematically illustrates a method for incremental SAT solving using clause tightening, in accordance with an embodiment of the present invention. In this method, SAT solver 50 shares conflict clauses among SAT instances in the manner described, for example, in the above-mentioned U.S. Pat. No. 7,047,139, in order to apply BMC-type verification to test the design of a target system, such as hardware model 36. The principles of incremental SAT solving itself are described in U.S. Pat. No. 7,047,139, as well as in other publications, and will not be repeated here.

To start the method, verification tool 40 defines multiple SAT instances, corresponding, for example, to different successive lengths of counterexamples in Bounded Model Checking (BMC) of the design under test, at an instance definition step 80. For each instance, SAT solver 50 attempts to find a satisfying assignment of the variables, using available conflict clauses to prune the search space, at a solution step 82. These conflict clauses may be derived during solution of the current SAT instance, and/or (except during processing of the first SAT instance) the SAT solver may use conflict clauses that were derived during the process of solving previous SAT instances. For conceptual simplicity, the derivation of such conflict clauses is represented separately in FIG. 4 as a new clause derivation step 84, although in practice this step is interleaved with step 82. The SAT solver saves new conflict clauses that it finds in each instance in clause database 52 for use in solving subsequent instances.

Periodically, SAT solver 50 attempts to tighten the conflict clauses in database 52 using constants that it has inferred, at a tightening step 88. The SAT solver may apply step 88 using the method of Table II. Typically, the inferred constants used at step 88 comprise unit conflict clauses that the SAT solver has derived, as described above. Alternatively, the constant values may apply to larger, multi-variable clauses, as noted above. The SAT solver may carry out step 88, for example, after it has finished solving each successive SAT instance. Alternatively, step 88 may be carried out whenever a new unit conflict clause is derived, or at other convenient intervals.

After completing the current instance and any consequent tightening of conflict clauses, SAT solver 50 goes on to solve the next SAT instance, at a SAT instantiation step 90, until all instances have been processed. Use of the tightened conflict clauses will generally enable the search space in these subsequent instances to be pruned more extensively, so that the SAT solver can find the solutions faster, at reduced computational cost.

When the SAT solver is used in the context of BMC, the number of transition steps represented by the SAT formula is limited. In some cases, even when the solver was unable to find a counterexample within this limited number of transition steps, there may still be a state of the design under test that is reachable in a greater number of steps and violates the specified property.

In response to this limitation, number of methods have been developed to enable the SAT solver to cover all reachable states of the system by successive over-approximations of the state space, and thus to verify that the property is satisfied on all states. For example, U.S. Pat. No. 6,944,838, whose disclosure is incorporated herein by reference, describes a design verifier that includes a bounded model checker, a proof partitioner and a fixed-point detector. If the bounded model checker does not find a counterexample at some depth K, the proof partitioner provides an over-approximation of the states that are reachable in one or more steps using a proof generated by the bounded model checker. (This sort of over-approximation is commonly known as a Craig interpolant.) The fixed-point detector detects whether the over-approximation is at a fixed point. If so, the design is verified. Another method that uses Craig interpolants in model checking (specifically for software) is described in U.S. patent application Ser. No. 11/551,264, filed Oct. 20, 2006, which is assigned to the assignee of the present patent application and whose disclosure is incorporated herein by reference.

The size of the interpolant that is used in the methods described above is generally proportional to the size of the proof of unsatisfiability. In an embodiment of the present invention, the method of proof tightening that is described above, as illustrated in Table III, for example, is applied to reduce the size of this proof, and thus to reduce the size of the interpolant. The precision of interpolation will accordingly be enhanced, thus reducing the time and computational resources required to verify the design.

Other methods of formal verification use an abstract model of the design under test, i.e., a model with a reduced number of variables. The unsatisfiable core of the proof of satisfiability of a given property may be used in generating and refining the abstraction that is used for this purpose. For example, McMillan and Amla describe this sort of method for model checking using proof-based abstraction-refinement in “Automatic Abstraction without Counterexamples,” Tools and Algorithms for the Construction and Analysis of Systems (2003), pages 2-17. The method of core tightening shown above in Table III may be applied to reduce the size of the unsatisfiable core, and thus provide a more efficient abstraction of the design. The method of Table III may similarly be applied, for example, in reducing the size of the unsatisfiable core that is used in iterative solution of Presburger formulas, as described by Kroening et al., in “Abstraction-Based Satisfiability Solving of Presburger Arithmetic,” Proceedings of the 16th International Conference on Computer Aided Verification—CAV '04 (Springer Verlag, 2004), pages 308-320; and solving BMC formulas corresponding to multi-threaded processes, as described by Grumberg et al., in “Proof-Guided Underapproximation-Widening for Multi-Process Systems,” Proceedings of the 32nd ACM SIGPLAN-SIGACT Symposium on Principles of Programming Languages—POPL '05 (ACM Press, 2005), pages 122-131.

Unsatisfiable cores are likewise used in other decision procedures, such as automated reasoning, artificial intelligence, and FPGA routing. The methods of core tightening that are described above may likewise be applied in enhancing the efficiency of such procedures.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A computer-implemented method for verification of a target system, the method comprising:
defining a formula describing the target system, the formula comprising clauses, which comprise variables and which express constraints on states of the target system;
processing the formula so as to derive, using the clauses, a proof relating to a property of the target system;
after deriving the proof, identifying a variable in the proof that has a constant value;
reducing a number of the variables in the proof using the identified variable, thereby producing a tightened expression;
applying the tightened expression in making a determination of whether the target system satisfies the formula; and
generating an output indicative of a verification status of the target system responsively to the determination.

2. The method according to claim 1, wherein defining the formula comprises defining multiple instances of a propositional satisfiability (SAT) problem relating to properties of the target system, wherein the tightened expression is produced responsively to solution of a first instance among the multiple instances, and wherein applying the tightened expression comprises, after solving the first instance, solving a second instance among the multiple instance using the tightened expression.

3. The method according to claim 2, wherein the tightened expression comprises a conflict clause, and wherein applying the tightened expression comprises combining the conflict clause with the clauses comprised in the formula in order to solve the second instance.

4. The method according to claim 1, wherein the clauses in the formula are arranged in a conjunctive normal form (CNF), and wherein processing the formula comprises proving a conflict clause by generating a resolution proof based on the clauses in the formula.

5. The method according to claim 4, wherein generating the resolution proof comprises building a directed acyclic graph (DAG) representing the resolution proof, the DAG comprising nodes connected by edges, and wherein reducing the number of the variables comprises applying an iterative procedure to the nodes using the identified variable in order to produce the tightened expression.

6. The method according to claim 5, wherein applying the iterative procedure comprises producing a tightened proof by eliminating one or more of the nodes in the DAG.

7. The method according to claim 5, wherein the nodes of the DAG comprise a root corresponding to a consequence of the resolution proof and leaves corresponding to the clauses that make up an unsatisfiable core of the root, and wherein applying the iterative procedure comprises reducing a size of the unsatisfiable core.

8. The method according to claim 4, wherein proving the conflict clause comprises producing a tightened clause by reducing the number of the variables in the conflict clause.

9. Apparatus for verification of a target system, the apparatus comprising:
a memory, which is arranged to store a formula describing the target system, the formula comprising clauses, which comprise variables and which express constraints on states of the target system; and
a processor, which is configured to process the formula so as to derive, using the clauses, a proof relating to a property of the target system, and after deriving the proof, to identify a variable in the proof that has a constant value, to reduce the number of the variables in the proof using the identified variable, thereby producing a tightened expression, and to apply the tightened expression in making a determination of whether the target system satisfies the formula.

10. The apparatus according to claim 9, wherein the formula defines multiple instances of a propositional satisfiability (SAT) problem relating to properties of the target system, and wherein the processor is configured to produce the tightened expression responsively to solution of a first instance among the multiple instances, and after solving the first instance, to solve a second instance among the multiple instance using the tightened expression.

11. The apparatus according to claim 10, wherein the tightened expression comprises a conflict clause, and wherein the processor is configured to combined the conflict clause with the clauses comprised in the formula in order to solve the second instance.

12. The apparatus according to claim 9, wherein the clauses in the formula are arranged in a conjunctive normal form (CNF), and wherein the processor is arranged to process the formula so as to generate a resolution proof of a conflict clause based on the clauses in the formula.

13. The apparatus according to claim 12, wherein the processor is configured to build a directed acyclic graph (DAG) representing the resolution proof, the DAG comprising nodes connected by edges, and to apply an iterative procedure to the nodes using the identified variable in order to produce the tightened expression.

14. The apparatus according to claim 12, wherein the tightened expression comprises a tightened clause, which is produced by the processor by reducing the number of the variables in the conflict clause.

15. A computer software product for verification of a target system, the product comprising a computer-readable medium in which program instructions are stored, which instructions, when read by a computer, cause the computer to accept a formula describing the target system, the formula comprising clauses, which comprise variables and which express constraints on states of the target system, and to process the formula so as to derive, using the clauses, a proof relating to a property of the target system, and after deriving the proof, to identify variable in the proof that has a constant value, to reduce the number of the variables in the proof using the identified variable, thereby producing a tightened expression, and to apply the tightened expression in making a determination of whether the target system satisfies the formula.

16. The product according to claim 15, wherein the formula defines multiple instances of a propositional satisfiability (SAT) problem relating to properties of the target system, and wherein the instructions cause the computer to produce the tightened expression responsively to solution of a first instance among the multiple instances, and after solving the first instance, to solve a second instance among the multiple instance using the tightened expression.

17. The product according to claim 16, wherein the tightened expression comprises a conflict clause, and wherein the instructions cause the computer to combine the conflict clause with the clauses comprised in the formula in order to solve the second instance.

18. The product according to claim 15, wherein the clauses in the formula are arranged in a conjunctive normal form (CNF), and wherein the instructions cause the computer to process the formula so as to generate a resolution proof of a conflict clause based on the clauses in the formula.

19. The product according to claim 18, wherein the instructions cause the computer to build a directed acyclic graph (DAG) representing the resolution proof, the DAG comprising nodes connected by edges, and to apply an iterative procedure to the nodes using the identified variable in order to produce the tightened expression.

20. The product according to claim 18, wherein the tightened expression comprises a tightened clause, which is produced by the computer by reducing the number of the variables in the conflict clause.
